(19) United States
(12) Patent Application Publication
(10) Pub. No.: US 2015/0033165 A1
(43) Pub. Date: Jan. 29, 2015

(54) DEVICE AND METHOD FOR CONTROLLING OBJECT ON SCREEN

(71) Applicant: Samsung Electronics Co., Ltd., Gyeonggi-do (KR)

(72) Inventors: Hyungseoung Yoo, Gyeonggi-do (KR); Joohyung Lee, Seoul (KR)

(21) Appl. No.: 14/446,158

(22) Filed: Jul. 29, 2014

(30) Foreign Application Priority Data
Jul. 29, 2013 (KR) 10-2013-0089299

(51) Int. Cl. G06F 3/0484; G06F 3/0486; G06F 3/0488; G06F 3/0481

(52) U.S. Cl. CPC G06F 3/04842; G06F 3/0481; G06F 3/04847; G06F 3/0486; G06F 3/0488
USPC 715/765

(57) ABSTRACT

A method for controlling an object on an electronic device having a touch screen is provided. The method includes displaying at least one object on the touch screen, receiving a first input on the touch screen, selecting an object from the at least one object, based on the first input, receiving a second input on an area other than the object in the touch screen, and modifying the selected object, based on the second input. An electronic device having a touch screen includes a touch screen configured to display at least one object on the touch screen, and a controller configured to receive a first input on the touch screen, select an object from the at least one object, based on the first input, receive a second input on an area other than the object in the touch screen, and control the selected object, based on the second input.

### CROSS-REFERENCE TO RELATED APPLICATION AND CLAIM OF PRIORITY

The present application is related to and claims the benefit under 35 U.S.C. §119(a) of a Korean patent application No. 10-2013-0089299 filed on Jul. 29, 2013 in the Korean Intellectual Property Office and assigned Serial, the entire disclosure of which is hereby incorporated by reference.

### TECHNICAL FIELD

The present disclosure relates to a device having a touch screen and a method for controlling an object and, more particularly, to a device and a method for controlling objects which enable an intuitive control of the object based on various touch gesture inputs.

### BACKGROUND

Recently, the market of touch screen is greatly expanding. In particular, the ratio of launching a touch panel is gradually increasing in the market of terminals and notebook computers, and the market of touch screens for portable equipments is rapidly increasing according to general application of touch screen panels in most smart phones. In the meantime, the application of touch screen panel is also increasing in the field of home appliances, and expected to have a higher market share in the field of touch screen panel application.

The touch screen has a structure of overlaying a surface for detecting an input and a surface for outputting a display. A device having a touch screen identifies and analyzes an input intended by a user through a touch gesture, and outputs the corresponding results. Namely, if the user transmits a control command to the device by inputting a touch gesture in the touch screen, the device can identify and analyze the user's intention by detecting a touch gesture input, process a corresponding operation, and output the result through the touch screen.

In the device having the touch screen, a user's touch gesture replaces a button input, and thereby conveniences in a user interface have been much improved. However, there are still a lot of subjects to be improved related to an intuitive control of objects.

### SUMMARY

A method for controlling an object on an electronic device having a touch screen is provided. The method includes displaying at least one object on the touch screen, receiving a first input on the touch screen, selecting an object from the at least one object, based on the first input, receiving a second input on an area other than the object in the touch screen, and controlling the selected object, based on the second input.

An electronic device having a touch screen includes a touch screen configured to display at least one object on the touch screen, and a controller configured to receive a first input on the touch screen, select an object from the at least one object, based on the first input, receive a second input on an area other than the object in the touch screen, and control the selected object, based on the second input.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of device having a touch screen according to an embodiment of the present disclosure;

FIG. 2 is a flow chart illustrating an operation of controlling an object in a device having a touch screen according to an embodiment of the present disclosure;

FIGS. 3A to 3C are screen examples illustrating an operation of controlling a size of an object according an embodiment of the present disclosure;

FIGS. 4A to 4C are screen examples illustrating an operation of controlling a size of an object according an embodiment of the present disclosure;

FIGS. 5A to 5C are screen examples illustrating an operation of controlling a size of specific object displayed in a touch screen according an embodiment of the present disclosure;

FIGS. 6A and 6B illustrates screen examples for an operation of controlling a size of popup window displayed in a touch screen according to an embodiment of the present disclosure;

FIGS. 7A and 7B illustrates screen examples for an operation of controlling an image insertion in a text editor according to an embodiment of the present disclosure;

FIG. 8 is a screen example illustrating a method of controlling an image size in a web browser according to an embodiment of the present disclosure;

FIG. 9 is a screen example illustrating an operation of controlling a size and a location of widget in a widget setting screen according to an embodiment of the present disclosure;

FIG. 10 is a screen example illustrating an operation of controlling a font size of text in a web browser according to an embodiment of the present disclosure;

FIGS. 11A to 11C are screen example illustrating an operation of editing an image in an image editor according to an embodiment of the present disclosure;

FIGS. 12A and 12B are screen example illustrating an operation of editing an image in an image editor according to an embodiment of the present disclosure;

FIGS. 13A and 13B are screen examples illustrating an operation of editing an image in an image editor according to an embodiment of the present disclosure;

FIGS. 14A and 14B are screen examples illustrating an operation of editing an image in an image editor according to an embodiment of the present disclosure; and

FIG. 15 is a screen example illustrating a method of selecting and controlling a portion of object displayed in a touch screen according to an embodiment of the present disclosure.

### DETAILED DESCRIPTION

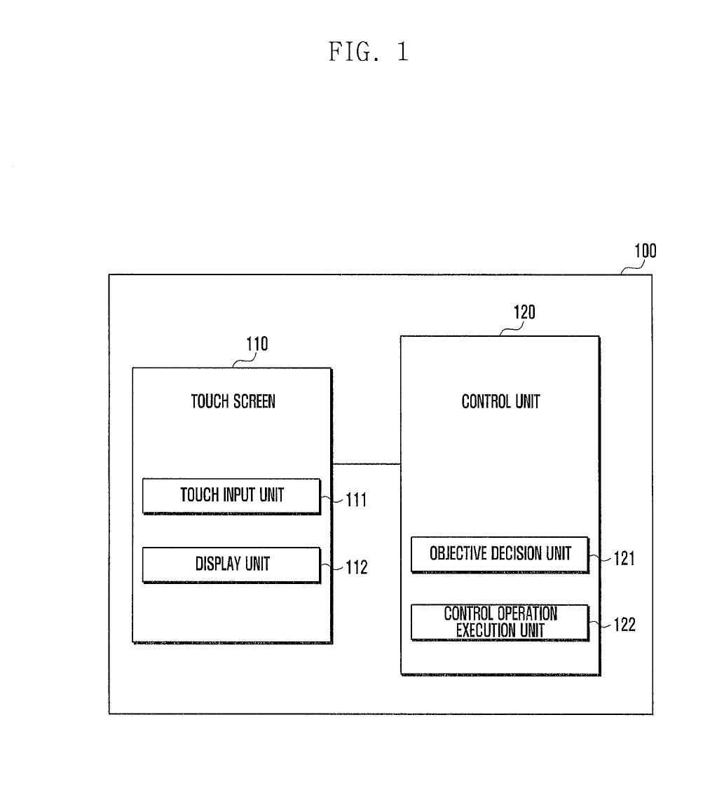

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, embodiments of the disclosure are described in detail with reference to the accompanying drawings. The same reference symbols are used throughout the drawings to refer to the same or like parts. Detailed descriptions of well-known functions and structures incorporated herein may be omitted to avoid obscuring the subject matter of the disclosure.

For the same reasons, some components in the accompanying drawings are emphasized, omitted, or schematically illustrated, and the size of each component does not fully reflect the actual size. Therefore, the present disclosure is not limited to the relative sizes and distances illustrated in the accompanying drawings.

A device having a touch screen described in the present disclosure and the accompanying drawings means a display device designed to perform a corresponding function by identifying and analyzing a contact part in the touch screen, if a user generates a gesture in the touch screen by using a finger or a touch pen in a ball point pen form.

A touch gesture described in the preset disclosure and the accompanying drawings may include a touch, tap, multi-tap, long tap, drag, drag & drop, and sweep. Here, the touch is an operation which the user presses a point in a screen. The tap is an operation of touching a point and taking off a finger without a lateral movement of the finger, namely, dropping. The multi-tap is an operation of tapping a point more than one time. The long tap is an operation of touching a point for a relatively long time and taking off a finger without a lateral movement of the finger. The drag is an operation of moving a finger in a lateral direction by maintaining a touch state. The drag & drop is an operation of taking off the finger after dragging. The sweep is an operation of taking off a finger after moving the finger in a fast speed like a spring action. The sweep is also called flick.

The touch gesture can include not only a single touch of touching a point in a touch screen with a single finger but also a multi-touch of touching at least 2 points in the touch screen with a multiple finger. If more than one touch is generated or if a time gap between touching a point and touching another point is smaller than a predetermined value, the operation can be identifies as a multi-touch.

Further, the touch gesture can include at least one touch input of different types. For example, the touch gesture can include a sweep as a first touch input and a tap as a second touch.

Various touch detection technologies such as a resistive type, capacitive type, electromagnetic induction type, and pressure type can be applied to the touch screen according to the embodiments of the present disclosure.

FIG. 1 is a block diagram illustrating a configuration of device having a touch screen according to an embodiment of the present disclosure.

Referring to FIG. 1, the device 100 can include a touch screen 110 and a control unit 120.

The touch screen 110 can be configured to receive a touch input and to perform a display operation. In more detail, the touch screen 110 can include a touch input unit 111 and a display unit 112.

The touch input unit 111 can receive a user's touch gesture generated on the surface of the touch screen. In more detail, the touch input unit 111 can include a touch sensor for detecting the user's touch gesture.

The display unit 112 displays various kinds of information related to the state and operation of the device 100, and each object is displayed in the display unit 112. The display unit 112 detects a user's gesture under the control of the control unit 120, and displays an operation of object control function corresponding to the detected touch gesture.

In more detail, the touch input unit 111 according to an embodiment of the present disclosure receives a first touch gesture and a second touch gesture. The first touch gesture can be an input operation for selecting a specific object from at least one object displayed in the touch screen. The first touch gesture can include selections of an object, border of object, and portion of object.

The second touch gesture is input after the first touch gesture, and can be a touch input operation in an area other than the entire or portion of the object selected from the touch screen. The second touch gesture can be input in various touch forms to intuitively control the selected entire or portion of object, such as a rotation gesture, enlargement gesture, and reduction gesture. The second touch gesture can be a single or multi-touch gesture, and the size of object can be enlarged or reduced according to the movement direction and distance of the touch gesture.

Besides the aforementioned functions, various object control functions mapped onto the second touch gesture can be prepared in the device 100. The mapping of the object control functions is preferably performed by intuitively matching a control function to be executed with a user's touch gesture. The second touch gesture can act as an input for executing the mapped object control function. The second touch gesture can include one or more touch input having identical or different functions.

The touch input unit 111 can receive an additional touch gesture for the selected entire or portion of object. Such a touch gesture can act as an input for moving the selected entire or portion of object on the touch screen.

The display unit 112 outputs the result of selecting and controlling the object responding to the first and second touch gestures transmitted from the touch input unit 111 to the control unit 120. The display unit 112 can activate the borders of the selected entire or portion of object corresponding to the first touch gesture, and display an operation of object control function corresponding to the second touch gesture.

The control unit 120 controls general operation of the device 100. If a touch gesture is received from the touch input unit 111 of the touch screen 110, the control unit 120 performs a corresponding function by detecting the touch gesture. In more detail, the control unit 120 can include an object decision unit 121 and a control operation decision unit 122.

The object decision unit 121 performs a function of deciding the entire or portion of object to be selected by detecting the first touch gesture received from the touch input unit 111. According to the settings, the object decision unit 121 selects an object if an object selection gesture such as a touch, long tap, multi-tap, or border drag operation is detected, and outputs the result through the display unit 112. If various touch gestures are detected for selecting a portion of object or for setting an area, the object decision unit 121 selects the corresponding portion and outputs the result through the display unit 112.

The control operation execution unit 122 detects a second touch gesture received from the touch input unit 111, decides a mapped control function correspondingly, performs the decided control function for the selected entire or portion of object, and outputs the result through the display unit 112.

The aforementioned configuration of the control unit 120 is an example for describing the operations of the control unit 120, and thereby is not limited to the example. It will be apparent to those skilled in the art that the control unit 120 performs general operation of the device.

Further, the control unit 120 can move the selected object on the touch screen based on an additional touch gesture in an area of the object selected from the touch screen.

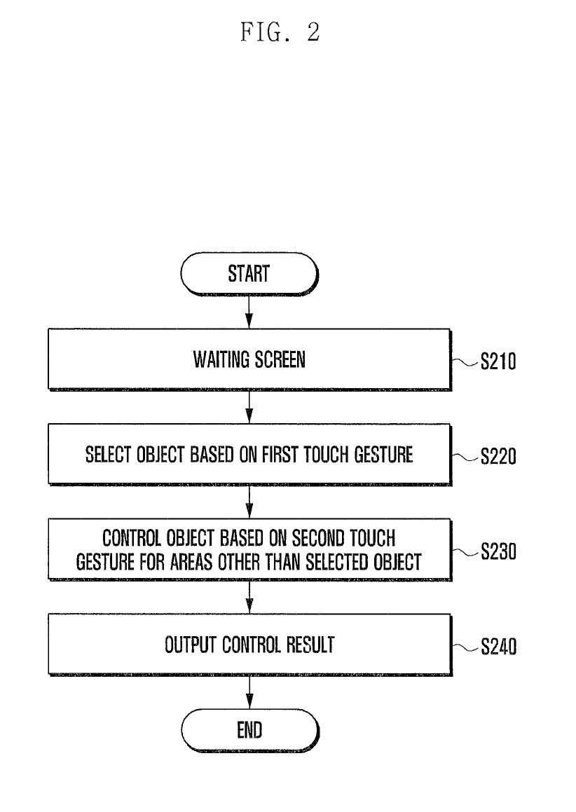

FIG. 2 is a flow chart illustrating a method of controlling an object in a device 100 having a touch screen according to an embodiment of the present disclosure.

The device 100 displays a waiting screen at operation S210. Here, the waiting screen can be various program execution screens such as a web browser and a text editor, and each screen can include at least one object.

The device 100 receives a first touch gesture and select an object accordingly at operation S220. Preferably, the first touch gesture can be a touch gesture generated in an object to be selected.

The device 100 receives a second touch gesture and controls the selected object accordingly at operation S230. Preferably, the second touch gesture can be a touch gesture generated in an area other than the selected object. As described above, the second touch gesture can be an intuitive gesture for controlling an object, and touch gesture information mapped onto various object control functions can be predetermined. Accordingly, a mapped object control function can be performed corresponding to the second touch gesture in this operation. In the meantime, if one touch input is completed in the second touch gesture, the object control of the corresponding touch input can terminate, or if a touch input satisfying the second touch gesture is again received, the object control can be re-performed corresponding to the touch input.

The device 100 outputs the result of object control based on the second touch gesture through the touch screen at operation S240. Here, an object control state corresponding to an ongoing second touch gesture as well as the result of the object control can be displayed in the touch screen.

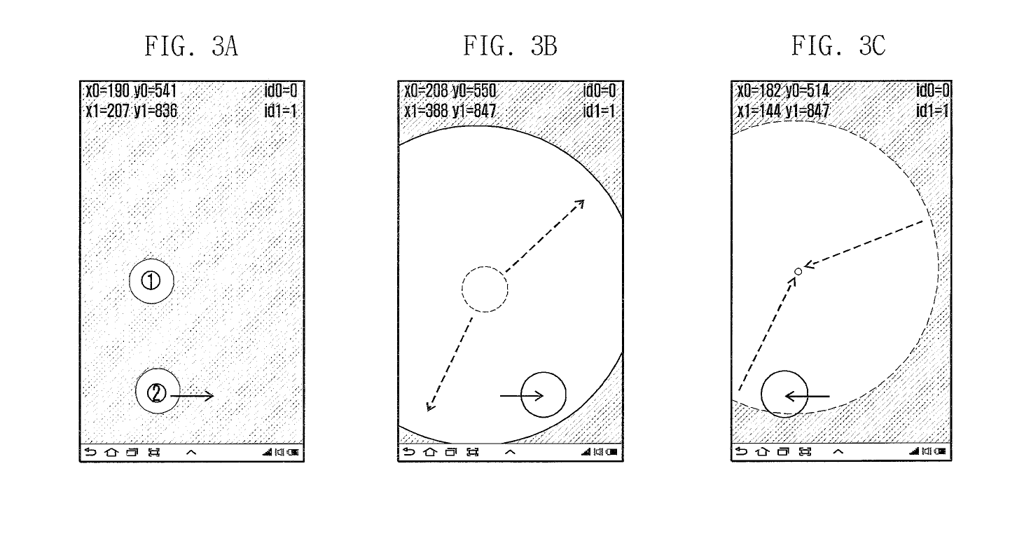

FIGS. 3A to 5C are screen examples illustrating the operations of controlling a size of specific object displayed on a touch screen according an embodiment of the present disclosure.

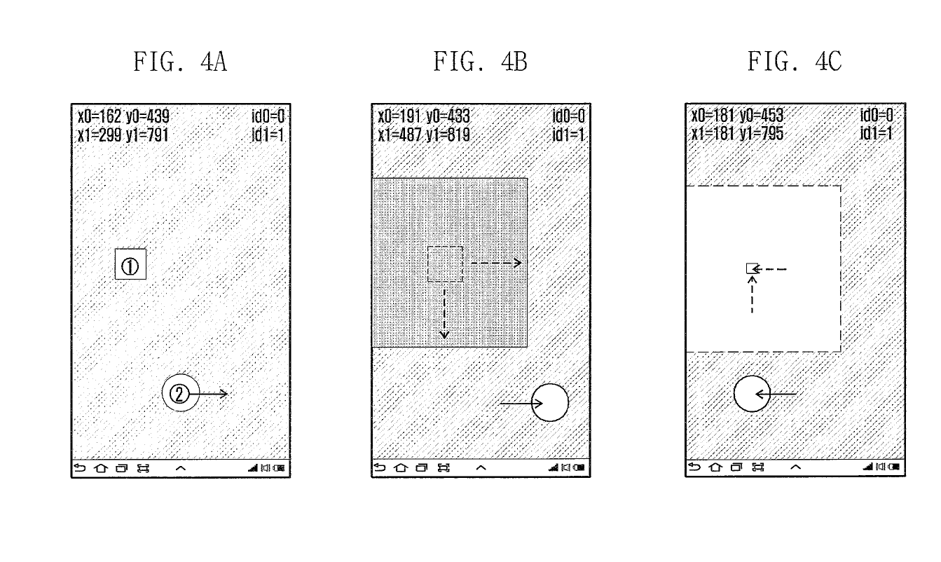

FIGS. 3A to 4C are screen examples illustrating the operations of controlling an object size based on a single touch.

Referring to the embodiments of FIG. 3A, an object is selected with a first touch (1) and the size of the selected object is controlled with a second touch gesture (2) having a specific direction in an area other than the selected object. If the selected object is a circle as shown in the screen example, the radius of the object can be increased by dragging in the rightward direction as shown in FIG. 3B and can be reduced by dragging in the leftward direction as shown in FIG. 3C. Namely, the size of object can be intuitively enlarged or reduced according to the dragging direction.

Referring to the embodiment of FIG. 4A, an object is selected with a first touch gesture (1) and the size of the selected object is controlled with a second touch gesture (2) having a specific direction in an area other than the selected object. If the selected object is a rectangle as shown in the screen example, the size of object can be increased proportional to a movement distance of dragging in the rightward direction and can be reduced proportional to a movement distance of dragging in the left direction as shown in FIG. 4B. Namely, the size of object can be intuitively enlarged or reduced according to the dragging direction.

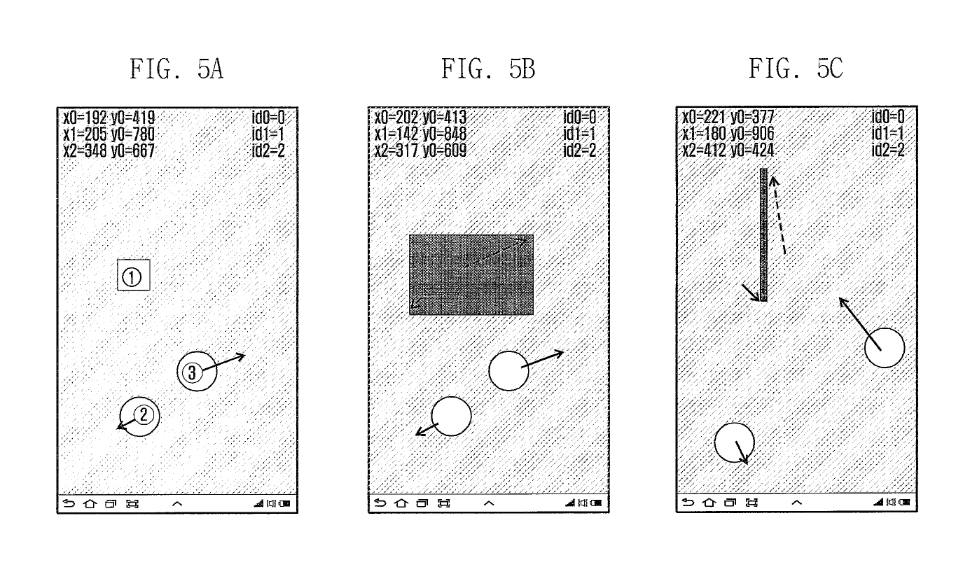

FIGS. 5A to 5C illustrate screen examples for modifying a size of an object, based on a multi-touch.

Referring to the embodiment of FIG. 5A, an object is selected by a first touch (1) and the selected object is controlled by receiving second touch gestures (2) and (3) based on a multi-touch. This embodiment illustrates a case that 2 touches are input simultaneously through the second touch gestures (2) and (3). As shown in FIGS. 5B and 5C, the size of the selected object can be intuitively enlarged or reduced according to the locations and movement directions of each touch input.

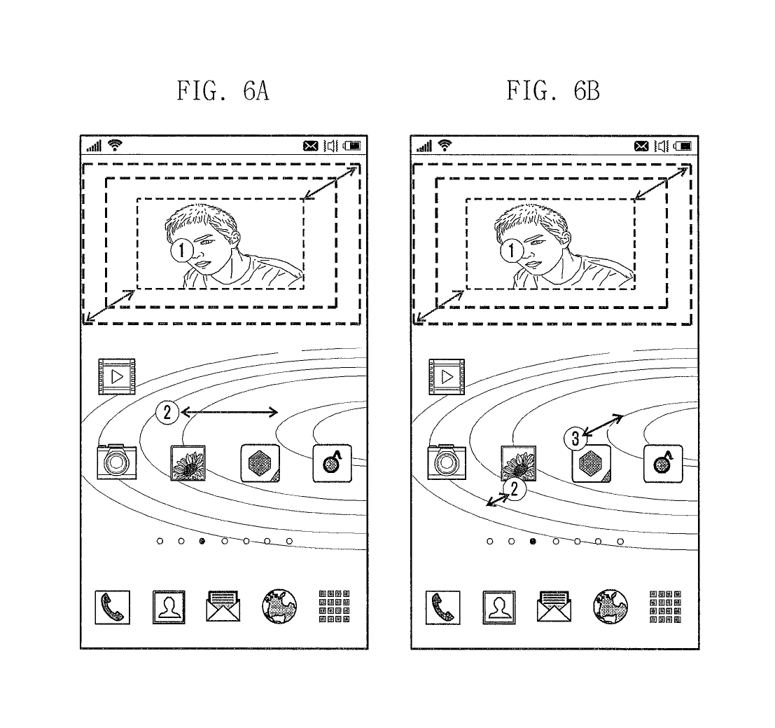

FIGS. 6A to 6B illustrate screen examples for the operations of controlling a size of popup window displayed in a touch screen according to an embodiment of the present disclosure.

The embodiment of FIGS. 6A to 6B illustrate an operation of selecting and controlling a popup window being played, in which the popup windows can be selected by a control object. As shown in FIG. 6A, a popup window is selected by a first touch gesture (1) and the size of the selected popup window can be controlled by a second touch gesture (2) having a specific direction in an area other than the selected popup windows. Alternatively, a popup window is selected by the first touch gesture (1) and the selected object can be controlled by receiving second touch gestures (2) and (3) based on a multi-touch from an area other than the selected popup window as shown in FIG. 6B. The size of the popup window can be intuitively enlarged or reduced according to the locations and movement directions of each touch input.

FIGS. 6A and 6B illustrates examples of controlling only the size of the popup window, however various function such as a play, temporary pause, rewind, and fast rewind, can be performed by mapping the functions in advance.

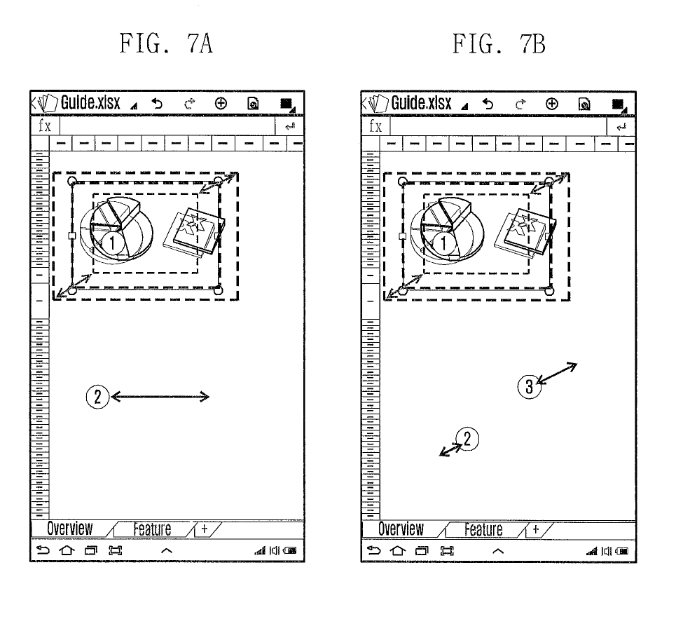

FIGS. 7A and 7B illustrate screen examples for a method of controlling an image insertion in a text editor according to an embodiment of the present disclosure.

This embodiment illustrates a method of inserting an image in a text being edited when the text editor is executed in a device having a touch screen. Referring to FIG. 7A, an image is firstly called in the text editor to insert the image in the text being edited. The image inserted in the text editor can be maintained in an activated state or activated by receiving a separate first touch gesture (1) for selecting the corresponding image. If the selection of the inserted image is already activated, the size of the selected image can be controlled by receiving a second touch gesture (2) having a specific direction in an image other than the activated image. FIG. 7B illustrates another embodiment of the text editor. Referring to FIG. 7B, an image is firstly called in the text editor to insert the image in a text being edited. The image inserted in the text editor can be maintained in an activated state or activated by receiving a separate first touch gesture (1) for selecting the corresponding image. If the selection of the inserted image is already activated, the size of the selected image can be controlled by receiving second touch gestures (2) and (3) based on a multi-touch in an area other than the activated image. The size of the image can be enlarged or reduced according to the locations and directions of the 2 touch inputs.

In the meantime, the location of the image can be moved by selecting the image, or after selecting the image, the selected image can be moved in the text area being edited by an additional touch gesture in the image selected from the touch screen.

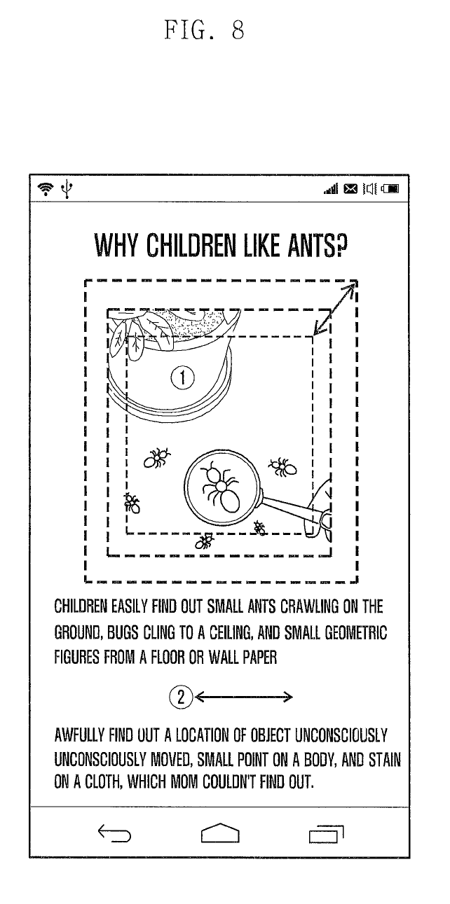

FIG. 8 is a screen example illustrating a method of controlling an image size in a web browser according to an embodiment of the present disclosure.

The web browser can include various contents in a screen, and thereby images desired by a user can be displayed in a relatively small size. According to the embodiment, the image desired by the user can be enlarged for easier identification. Referring to FIG. 8, a first touch gesture (1) can be received to select an image to be enlarged from various contents displayed in the web browser. If the image is selected, the size of the selected image can be controlled by a second touch gesture (2) having a specific direction in an area other than the image selected from the web browser.

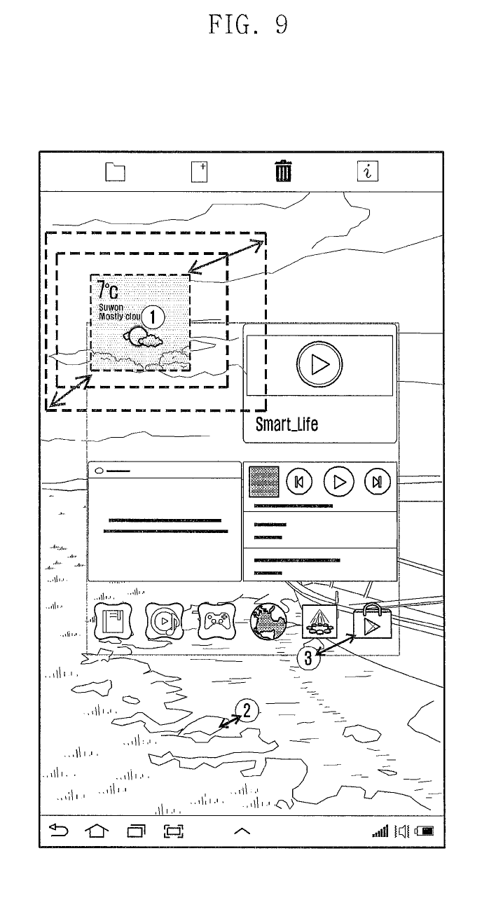

FIG. 9 is a screen example illustrating a method of controlling a size and a location of widget in a widget setting screen according to an embodiment of the present disclosure.

The device can perform various functions and include mini applications called widgets in a home screen or a desktop screen, from which a user can select a mainly used function. The user can set the widget having a desired function in the home screen or desktop screen. Referring to FIG. 9, a desired widget is selected by receiving a first touch gesture (1) in a widget setting mode, and the size of selected popup window can be controlled by second touch gestures (2) and (3) having s specific direction in an area other than the selected widget. Further, the location of the widget can be moved by selecting the widget, or after selecting the widget, the location of the selected widget can be moved by an additional touch gesture in the widget selected from the touch screen.

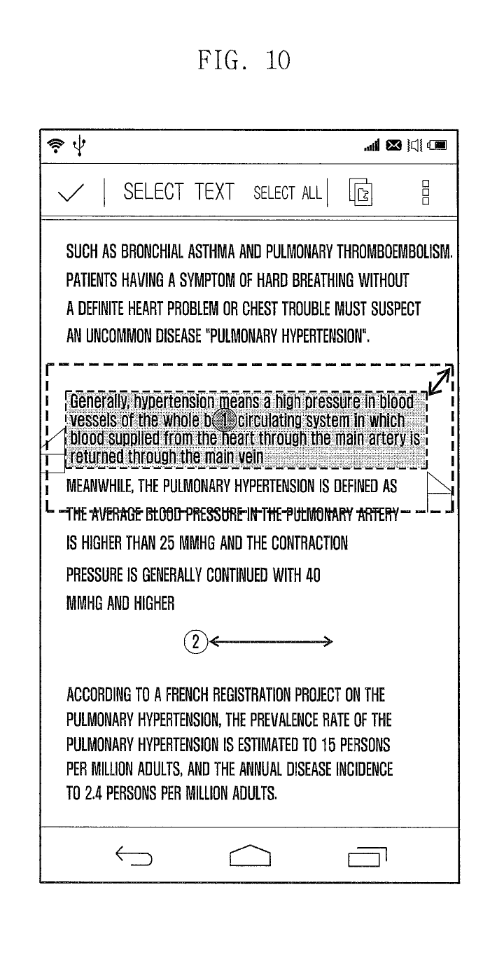

FIG. 10 is a screen example illustrating the operation of controlling a font size of text in a web browser according to an embodiment of the present disclosure.

The web browser can include various contents in a screen, and thereby images desired by a user can be displayed in a relatively small size. This embodiment provides a method of displaying a desired text by enlarging in the web browser. Referring to FIG. 10, a first touch gesture (1) is received to select a text to be enlarged from texts included in a web browser screen. Here, the area of the selected text can be set by a touch & drag operation. If the text is selected, the font of the selected text can be controlled by a second touch gesture (2) having a specific direction in an area other than the range of the text selected from the web browser.

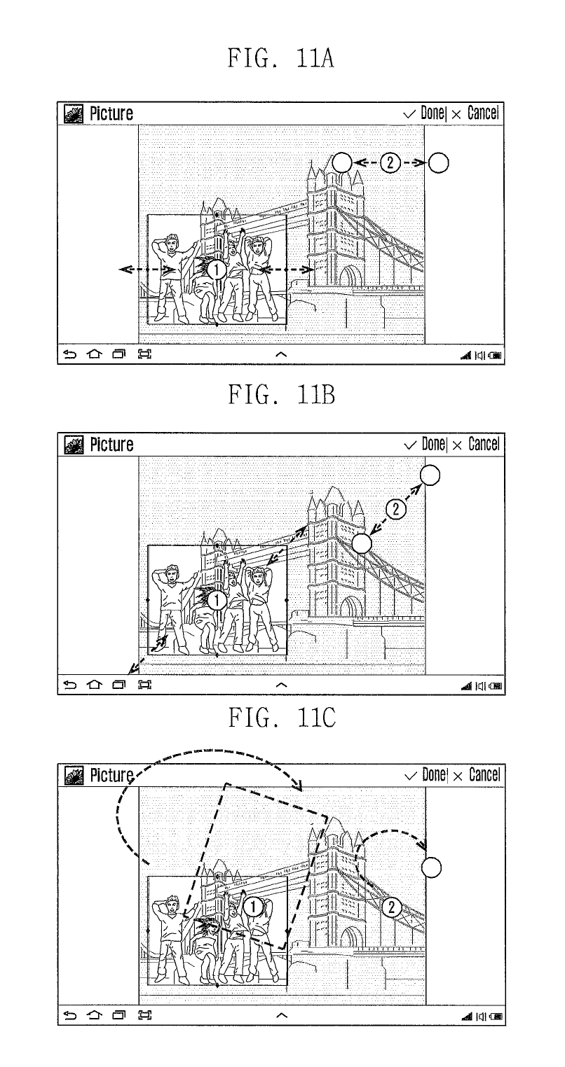

FIGS. 11A to 14B are screen example illustrating the operation of editing an image in an image editor according to an embodiment of the present disclosure.

FIG. 11A to FIG. 11C illustrate screen examples for the operation of controlling a size and a rotation of an image selected to edit in an image editor.

An image is firstly called in an image editor and an activated edit area is selected by moving an edit window with a first touch gesture (1). Subsequently, the size of the activated edit area can be controlled by a second touch gesture (2) having a specific direction in an area other than the activated edit area (i.e., edit window) of the image editor. Here, the size of the activated edit area can be controlled corresponding to a user's intuitive touch gesture. If the second touch gesture is received in FIG.11A, the right and left sides of the edit window can be enlarged or reduced. If the second touch gesture is received as shown in FIG. 11B, the edit window can be enlarged or reduced in a diagonal direction.

In another embodiment illustrated in FIG. 11C, an image is firstly called in the image editor and an activated edit area is selected by a first touch gesture (1). Subsequently, the edit window can be rotated by a second touch gesture (2) of drawing a circle in an area other than the activated edit area (i.e., edit window) of the image editor. Here, the edit window can be controlled corresponding to the user's intuitive touch gesture.

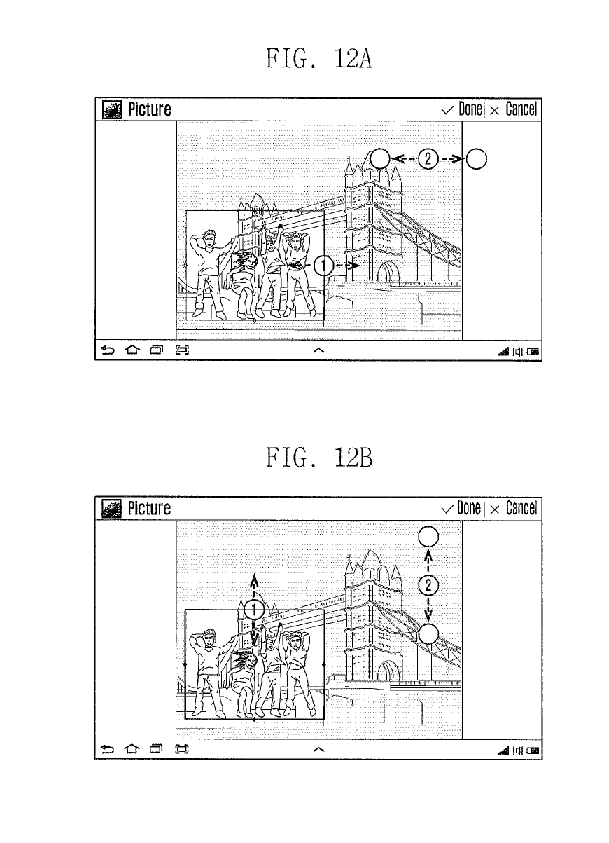

FIGS. 12A and 12B illustrate screen examples for the operation of controlling a portion of images area (i.e., border) to be edited in an image editor.

As illustrated in FIGS. 12A and 12B, an image is firstly called in the image editor, and an activated edit area is selected by moving an edit window with a first touch gesture (1) and the border of the edit window is also selected. Here, the selection of the border is performed by touching the border. Subsequently, the border can be controlled by a second touch gesture (2) having a specific direction in an area other than the activated edit area (i.e., edit window) of the image editor. Here, the border can be enlarged or reduced corresponding to the user's intuitive touch gesture.

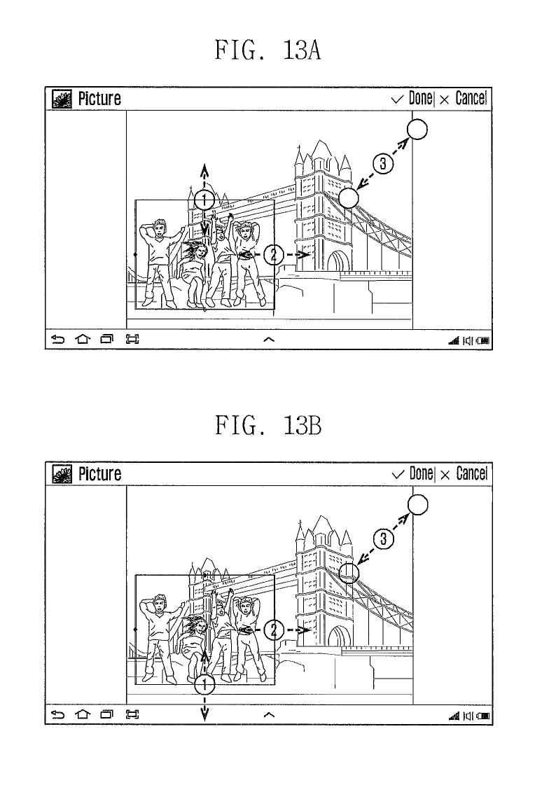

FIGS. 13A and 13B are screen examples illustrating the operation of selecting and controlling a plurality of borders of images area to be edited in an image editor.

Referring to FIGS. 13A and 13B, an image is firstly called in the image editor, and an activated edit area is selected by moving an edit window with first touch gestures (1 and 2) and the border of the edit windows is also selected. The selection of the border is performed by touching the border. Subsequently, the border can be controlled by a second touch gesture (3) having a specific direction in an area other than the activated edit area (i.e., edit window) of the image editor. Here, the border can be enlarged or reduced corresponding to the user's intuitive touch gesture.

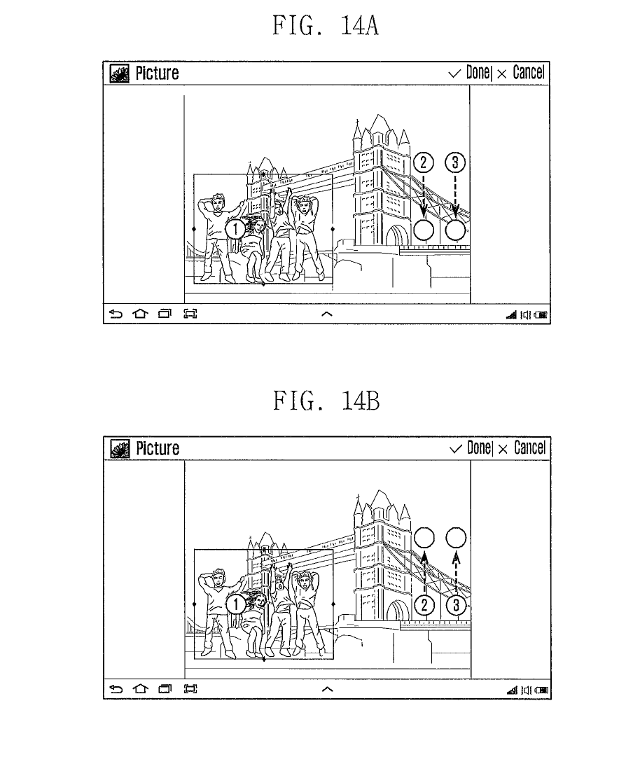

FIGS. 14A and 14B are screen examples illustrating the operations of performing various control functions for an image area selected to edit in an image editor.

Referring to FIGS. 14A and 14B, an image is firstly called in the image editor, and an activated edit area is selected by moving an edit window with first touch gesture (1). Subsequently, a control function mapped onto a corresponding touch gesture can be performed by receiving second touch gestures (2) and (3) from an area other than the activated edit area (i.e., edit windows). The control function mapped onto the touch gesture may be predetermined. For example, if a multi-touch and a drag in a specific direction are received as shown in FIGS. 14A and 14B, control functions mapped onto each corresponding input, such as an undo function or a redo function, can be performed.

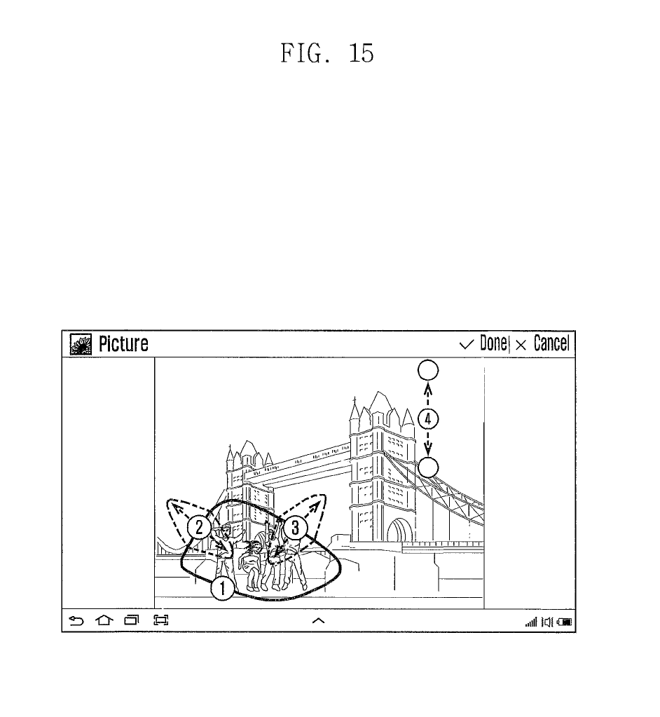

FIG. 15 is a screen example illustrating a method of selecting and controlling a portion of object displayed in a touch screen according to an embodiment of the present disclosure.

Referring to FIG. 15, a portion of a displayed object is firstly selected by first touch gestures (1, 2, and 3). The portion of the object displayed in the touch screen can be set with a touch input (1), and specific borders of the selected object can be selected with touch inputs (2) and (3). After selecting the borders, the selected borders can be enlarged or reduced by a second touch gesture (4) having a specific direction in an area other than the portion of the object selected from the touch screen.

According to the present disclosure, a user can control an object in a more effective and intuitive method in a device having a touch screen, and the efficiency of receiving a user's touch gesture input for the object control is improved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling an object on an electronic device having a touch screen, the method comprising:
displaying at least one object on the touch screen;
receiving a first input on the touch screen;
selecting an object from the at least one object, based on the first input;
receiving a second input on an area other than the object in the touch screen; and
controlling the selected object, based on the second input.

2. The method of claim 1, wherein the controlling of the selected object comprises performing a function related to the selected object mapped onto the second input.

3. The method of claim 1, wherein the second input is dragging on the touch screen.

4. The method of claim 3, wherein the controlling of the selected object comprises enlarging or reducing the size of the selected object, if the second input is of a directional nature.

5. The method of claim 3, wherein the controlling of the selected object comprises enlarging or reducing a font size of a text, if the selected object is the text and the second input is of a directional nature.

6. The method of claim 1, wherein when the second input is rotating on the touch screen, the controlling of the selected object comprises rotating the selected object corresponding to a rotation of the second input.

7. The method of claim 1, wherein the selecting of the object further comprises selecting a border of at least specific area of the selected object.

8. The method of claim 7, wherein the controlling of the selected object further comprises enlarging or reducing the selected border of the selected object, if the second input is of a directional nature.

9. The method of claim 2, wherein the function related to the selected object is performed based on a number of a touch input on to the touch screen and a direction of the touch input, if the second input comprises the touch input and the touch input is of a directional nature.

10. The method of claim 1, wherein once the object is selected, the selected object is moved on the touch screen, according to a subsequent input.

11. An electronic device having a touch screen, the device comprising:
a touch screen configured to display at least one object on the touch screen; and
a controller configured to:
receive a first input on the touch screen;
select an object from the at least one object, based on the first input;
receive a second input on an area other than the object in the touch screen; and
control the selected object, based on the second input.

12. The electronic device of claim 11, wherein the controller is further configured to perform a function related to the selected object mapped onto the second input.

13. The electronic device of claim 11, wherein the second input is dragging on the touch screen.

14. The electronic device of claim 11, wherein the controller is further configured to enlarge or reduce the size of the selected object, if the second input is of a directional nature.

15. The electronic device of claim 13, wherein the controller is further configured to enlarge or reduce a font size of a text, if the selected object is the text and the second input is of a directional nature.

16. The electronic device of claim 11, wherein the controller is further configured to rotate the selected object corresponding to a rotation of the second input, when the second input is rotating on the touch screen.

17. The electronic device of claim 11, wherein the controller is further configured to select a border of at least specific area of the selected object.

18. The electronic device of claim 17, wherein the controller is further configured to enlarge or reduce the selected border of the selected object, if the second input is of a directional nature.

19. The electronic device of claim 12, wherein the controller is further configured to perform the function related to the selected object based on a number of a touch input on to the touch screen and a direction of the touch input, if the second input comprises the touch input and the touch input is of a directional nature.

20. The electronic device of claim 11, wherein the controller is further configured to move the selected object on the touch screen according to a subsequent input once the object is selected.
